(19) United States
(12) Patent Application Publication
(10) Pub. No.: US 2010/0023391 A1
(43) Pub. Date: Jan. 28, 2010

(54) SYSTEM AND METHOD FOR TRACKING COMMERCIAL ACTIVITY

(76) Inventors: Peter R. Hudetz, Naperville, IL (US); Frank C. Hudetz, Naperville, IL (US)

Correspondence Address: BRINKS HOFER GILSON & LIONE, P.O. BOX 10395, CHICAGO, IL, 60610, US

(21) Appl. No.: 12/180,050

(22) Filed: Jul. 25, 2008

(51) Int. Cl. G06Q 30/00; G06Q 90/00; G06F 19/00

(52) U.S. Cl. 705/14.41; 235/375; 705/14.66

(57) ABSTRACT

A method tracking commercial activity that can be initiated by a print or electronic media provider and that includes creating an insert that contains unique code information and associating the code information with a particular recipient for tracking consumer transactions by imaging a code or applying electromagnetically-readable media onto an insert and applying recipient information onto a mailing host. The code and recipient information are maintained on a relational database and the mailing host and insert are delivered to a recipient. When the recipient takes some action with the insert, the insert use information by the particular recipient is collected and the relational database is used to identify the recipient. A marketing database is then created from the insert use information by the particular recipient. In one method, the code information on the insert and the recipient information are recorded by a publisher during binding and processing of a magazine, catalogue, or loose leaf mailing.

### TECHNICAL FIELD

The invention relates, generally to systems and methods for determining effectiveness of marketing activity directed to business and consumers, and, more particularly, to systems and methods for collecting information on consumer responses to marketing vehicles produced by printing and electronic media industries.

### BACKGROUND

Marketing companies continually seek consumer information that will enable them to better focus their marketing efforts to address particular consumer interests. One important source of consumer information is through redemption of special offers and discounts offered to consumers. These are typically sent to consumers through the mail. Although, with the increased use of the internet as a means of commerce, special offers and discounts are often sent electronically to consumers or displayed on a web site.

One common method to communicate special offers and discounts to consumers is through the use of coupons and flyers. Coupons are distributed in any number of different methods, including in-store flyers, on-product delivery, by insertion into magazines and newspapers for delivery to consumers, and by direct mailings.

Once a consumer accepts an offer by redeeming a coupon or submitting the offer to a retailer, the marketing companies use, the marketing companies use the acceptance as an opportunity to collect consumer information. For example, in addition to the interest in the particular product or service offers, consumer characteristics such as gender, age, marital status, household income, product needs can sometimes also be obtained. Once this information is acquired, marketing companies tailor their marketing efforts for specific products to specific consumers, or provide price reductions to specific consumers. In addition, particular marketing campaigns can be directed to particular retailers having customers interested in particular products.

Most coupons currently include text communicating an advertising message and a uniform product code (UPC) bar code. The UPC bar code provides information about the manufacturer and brand of the product being discounted, the type of product being discounted, and the amount of discount being provided to the consumer by the coupon. The bar codes on the coupons are designed to be scanned at the time of purchase of the goods such that the point of sale terminal may verify that the coupon is valid and is being redeemed for a purchased product. The retailer then transmits the data to the marketing company or other information collecting entity. One such method is disclosed by U.S. Pat. No. 6,230,143, in which a two dimensional bar code is placed on coupons. The bar code includes consumer identity information so that, when the coupon is presented and the bar code is scanned, information is collected on the particular consumer's use of the coupon.

In addition to mailing information to consumers, electronic media is now employed by marketing companies to communicate special offers to consumers. As described above, advertising offers can be directed through electronic mail and displayed on a provider's web site. Many consumers learn of resources on the Internet or a proprietary on-line service through magazine articles and advertisements. These articles and advertisements include the necessary uniform resource locator (URL) or other network address to access the product web site. The web sites on the internet can be accessed by the consumer through their home or business computer. A web server operated by the retailer accepts interacts with the consumer's computer to establish file transfers. The consumer enters the published URL or other mnemonic address to access the web site. The retailer then transmits consumer information to the marketing company or other information collecting entity.

While the foregoing marketing techniques and data collection methods are currently practiced, the information collection methods are limited to data collection by marketing companies through a retailers or coupon redemption centers. The publishers of the print or electronic media do not have an active roll in obtaining or processing the consumer information. It would be advantageous if the publishers and producers of print and electronic media could become directly involved in the collection and processing of consumer purchasing information. More efficient data processing and information analysis could be carried out by reducing the level of retailer involvement in data collection and processing.

### SUMMARY

In one embodiment, a method for tracking advertising effectiveness by a mailing originator includes pre-imaging a code onto an insert and applying recipient information onto a mailing host, associating the code with the recipient information, and creating a log file. The mailing host and the insert are delivered to the recipient and insert use information by the recipient is collected using the log file to identify the recipient, and a marketing database is created.

In another embodiment, a method for tracking consumer transactions using inserts having random codes thereon includes scanning the random code on an insert, applying recipient information onto a mailing host, associating the random code with the recipient information, and creating a file log. The insert is associated with the mailing host and the mailing host and the insert are delivered to a recipient. The random code is received and the log file is used to identify the recipient, and a marketing database is created.

In yet another embodiment, a method for tracking commercial activity, the method includes imaging an insert with dynamic information, associating the insert with a mailing host, applying recipient identification information to the mailing host, and creating a log file. The mailing host and the insert are delivered to the recipient and the dynamic information is collected and the log file is used to identify the recipient, and a marketing database is created.

### BRIEF DESCRIPTION OF THE DRAWING

FIG. 1 is a block diagram of a system and method for imaging information and building a relational database in accordance with an aspect of the invention;

FIG. 2 is a schematic diagram illustrating various kinds of information that is imaged on inserts in accordance with an aspect of the invention;

FIG. 3 is a schematic drawing of articles of commerce including a code image thereon in accordance with an aspect of the invention;

FIG. 4 is a tablature view arranged in accordance with an aspect of the invention for the relational database illustrated in FIG. 1;

FIG. 5 is a block diagram illustrating a system and method for collecting and processing consumer information in accordance with an aspect of the invention;

FIG. 6 illustrates a system for collating an imaging document and creating a file log in accordance with an aspect of the invention; and

FIGS. 7 and 8 illustrate alternative methods for imaging codes and other dynamic information on inserts in accordance with an aspect of the invention.

### DETAILED DESCRIPTION

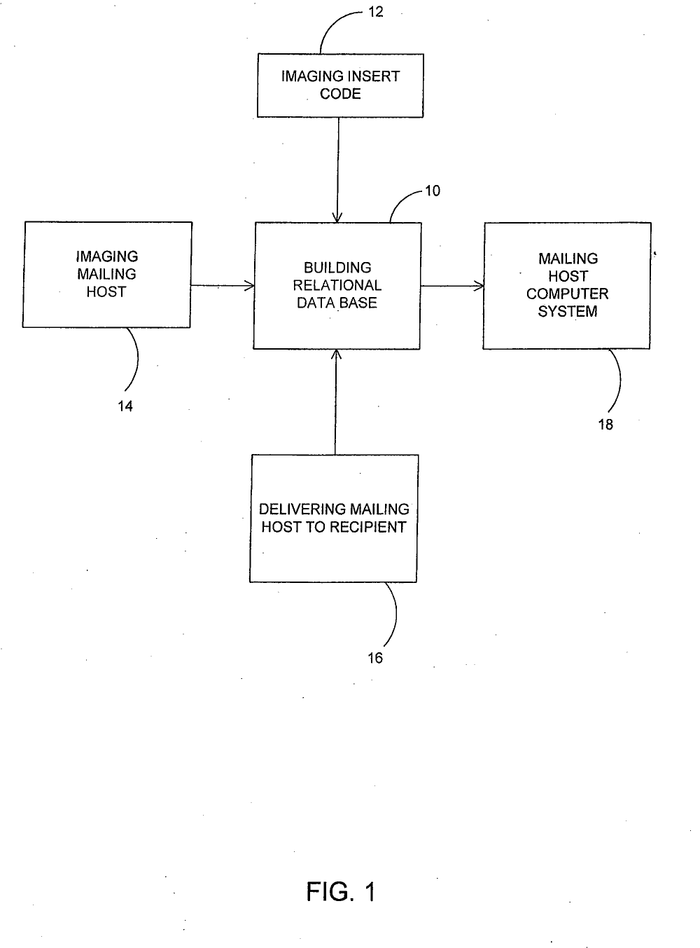

Shown in FIG. 1 is a block diagram of several components of a tracking system and method for imaging information and building a relational database 10. Relational database 10 includes information imaged on a mailing host and an insert placed into the mailing host. In block 12, dynamic information or a code is imaged onto an insert. The code can be a random number or a sequence number. In addition, the code can include numeric keys that indicate various kinds of information including product codes, geographic marketing information, and the like. In an alternative embodiment, the code can be embodied in a magnetically-readable media applied to the insert.

In block 14, recipient information is imaged onto a mailing host. The recipient information includes name and address of the recipient, and can also include additional information such as previous purchase activity, product preferences, personalized messages, and the like. As will be described below, the mailing host can be a wide variety of print media and electronic media.

The code imaged on or applied to the insert and the recipient information imaged on the mailing host are retained in the relational database. The relational database also contains information regarding the delivery of the mailing host to a recipient. The delivering information 16 is maintained in the relational database to record mailing particulars, such as method of delivery timing of delivery, and related information. As will subsequently be described, the information stored in relational database 10 can be produced and collected on a real-time basis during the imaging, collating, and, in certain instances, binding processes. Imaging of the insert and the mailing host can be carried out at the same time, or alternatively, the insert can be imaged at an earlier point in time prior to imaging the mailing host.

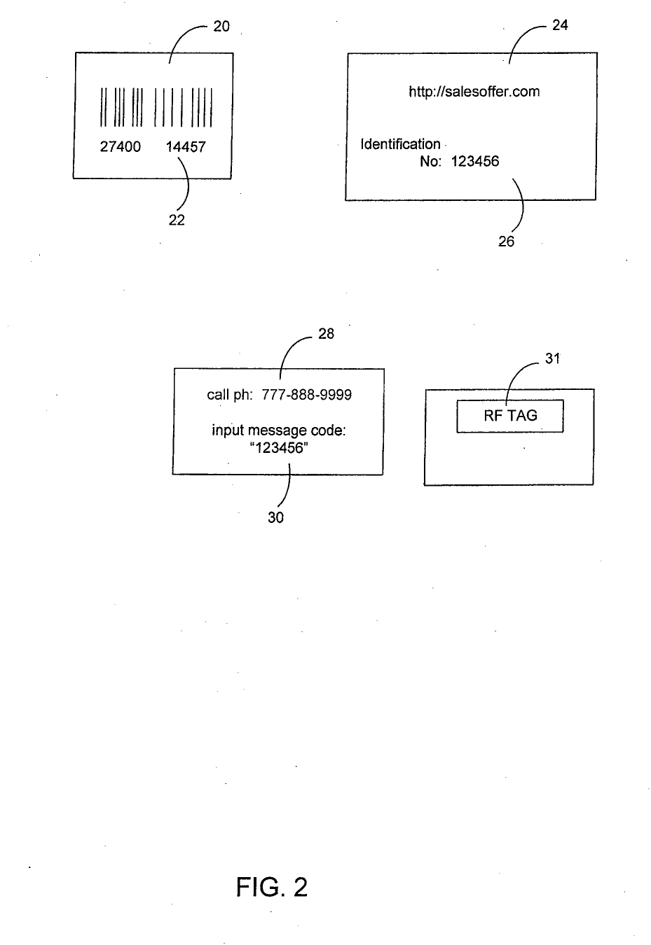

An exemplary information table is illustrated in FIG. 2 showing various types of information that can be included in relational database 10. As illustrated in FIG. 2 relational database includes the type of mailing, such as a magazine, loose leaf flyer, newspaper, catalogue, and the like. Relational database 10 further includes the particular dynamic information or code imaged on the insert. A wide variety of information can be contained in the insert code, including product identification information, particular pricing information, and the like. In accordance with the invention, an identifying code is included on the insert. This information can be imaged in a variety of formats, including bar codes, alpha numeric codes, text, and the like. Relational database 10 also includes recipient information, such as name, address, and other information on individual recipient. Further, relational database 10 can include descriptions of product type and other marketing information useful for characterizing the behavior of the recipient upon utilizing the insert code information.

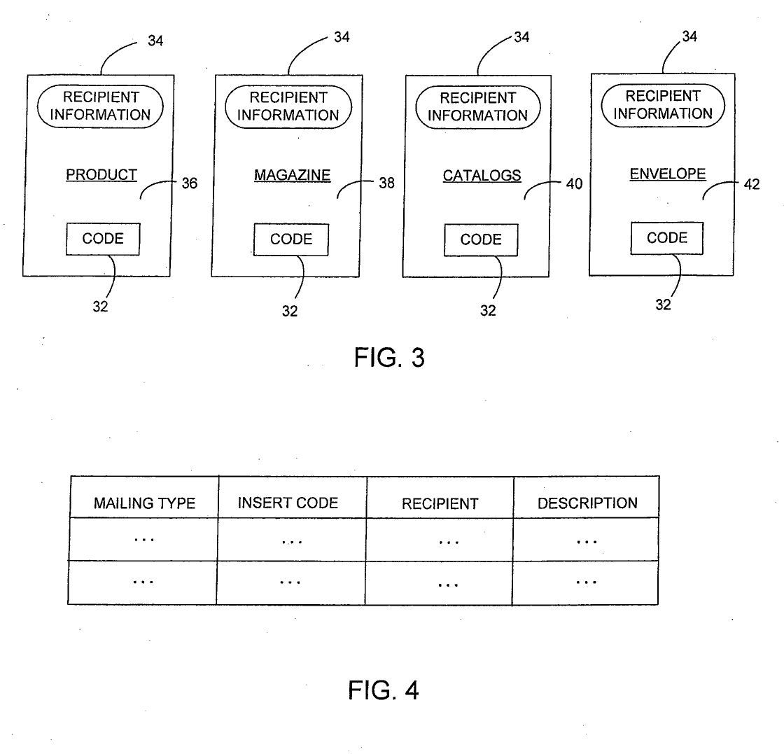

FIG. 3 is a schematic diagram illustrating some of the various formats for code information imaged that is imaged on or applied to the insert. For example, the insert can include bar codes, such as bar code 20. Bar code 20 can include an extensive array of information that will enable tracking of the insert usage by the recipient. For example, the bar code can include different fields that identify a particular manufacturer and a particular product. Further, in accordance with the invention, a numeric field 22 includes a specific tracking code that is used by the tracking system to match the insert with a particular recipient.

In addition to bar codes, other types of information can be imaged on the insert. For example, URL 24 and identification number 26 can be printed on the insert. To take advantage of an offer for a particular product or service, the recipient enters the URL 24 into their home or office computer. The website host then prompts the recipient to enter the identification code 26. Once the code is entered, the tracking system identifies the recipient using relational database 10.

Yet another example of insert code information in accordance with the invention includes a telephone number 28 and text message 30. To take advantage of the particular offer identified on the insert, the recipient calls telephone number 28 and is then prompted by a telecommunications center to enter text message code 30. Once the code is entered, the tracking system identifies the recipient using relational database 10.

In a still further example, the code can be transmitted by an RF tag or magnetic strip 31 that is applied to the insert. The RF tag or magnetic strip is scanned and the code information is transmitted to a detector, which then relays code information to tracking system. As in above methods, once the code is entered, the tracking system identifies the recipient using relational database 10.

FIG. 4 schematically illustrates various types of mailing hosts. Each mailing host includes an insert bearing code 32 and recipient information 34. In addition to conventional coupon in the form of a paper or plastic card code 32 can be imaged on a product 36 delivered to the recipient in a package or attached to a publication for example. Further, the mailing host can be a product 36, a magazine 38, a catalogue 40, or an envelope 42. Those skilled in the art will recognize that other types of mailing hosts are possible, such as cartons, boxes, shipping container, and the like.

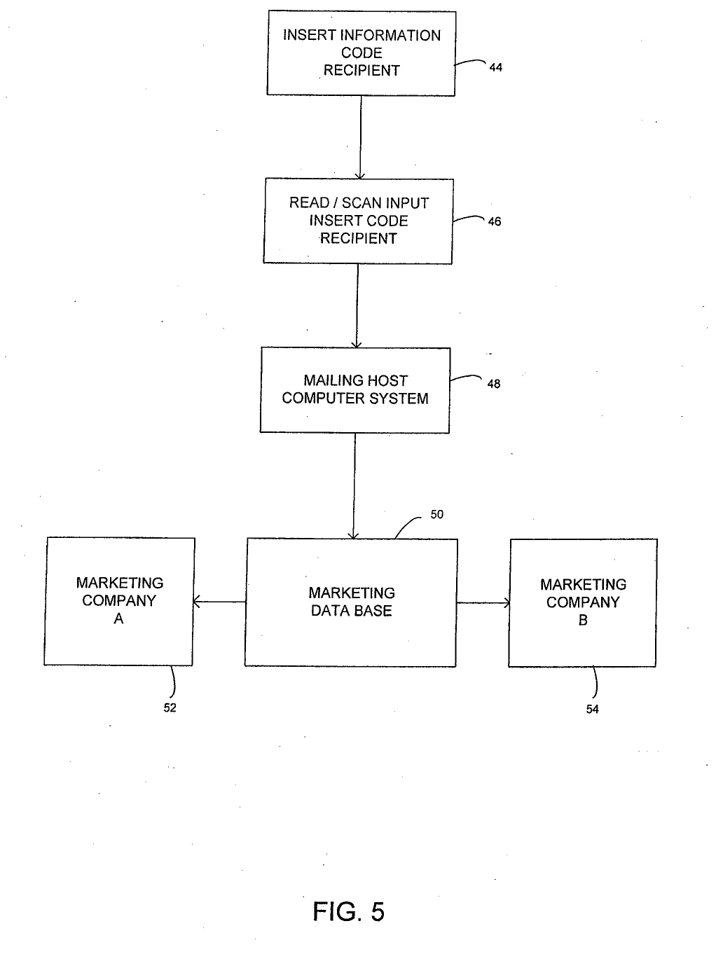

FIG. 5 illustrates a system and method for collecting insert use information by the recipient. In step 44, the recipient takes one of the actions described above that will provide the system operator with code 32 that was delivered to the recipient with the insert. At step 46, code 32 is entered into the system by one of a variety of methods. As previously described and illustrated in FIG. 3, in accordance with the invention a variety code formats can be used. The particular method of inserting code 32 will depend upon the particular type of code that is included on the insert. For example, the code can be read from the insert, scanned from the insert, typed into a computer file, sensed by a remote sensing device, and the like.

At step 48, the code information is transmitted to the mailing host computer system 18. The mailing host computer system 18 associates the code with recipient information and creates a marketing database 50. Marketing database 50 contains valuable marketing information regarding transactions carried out by particular identified consumers that can be used for a wide variety of information. For example, the information and marketing database 50 can be used to evaluate the effectiveness of various types of advertising, particular product interest by a group of consumers, the effectiveness of various insert delivery methods, and the like. In addition, the particular way in which the information was received, such as through a clearing house, or an electronic tracking center, or the like, can be maintained in the marketing base.

The information in marketing database 50 can be distributed to different marketing companies, depending upon a variety of commercial arrangements. For example, the print and/or electronic media companies can contract with various marketing firms 52 and 54 to provide marketing information.

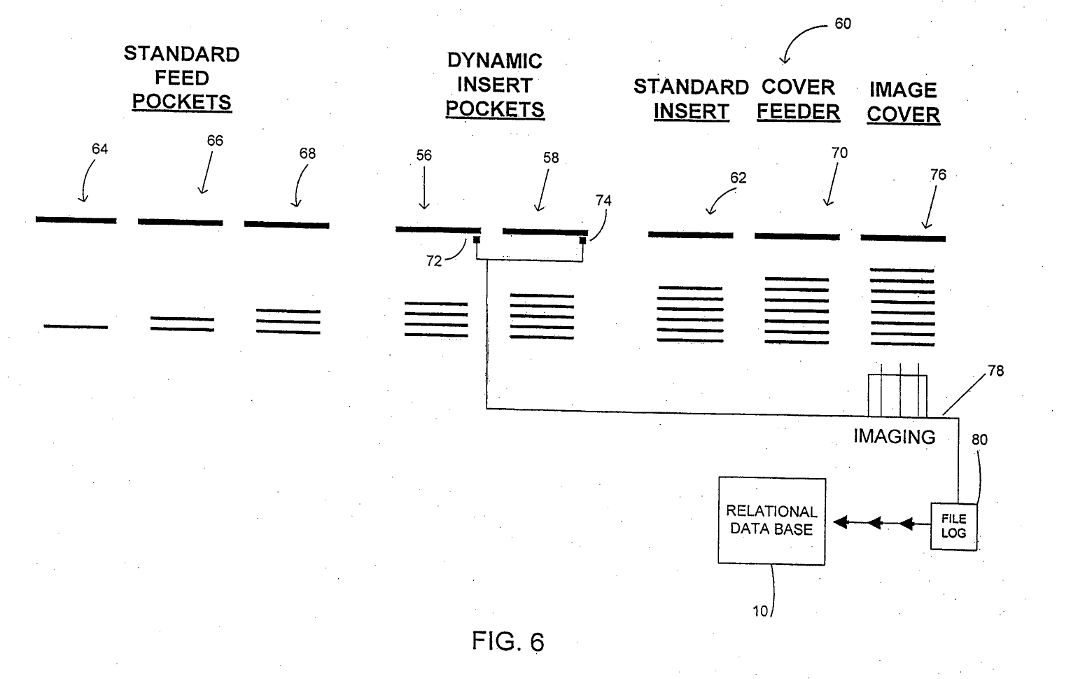

FIG. 6 schematically illustrates a processing method for collating inserts and additional sheets into groups of sheets for packaging or binding. For example, as illustrated in FIG. 6, insert sheets are arranged in pockets 56 and 58 in a collation line 60. Additional inserts can be arranged in pocket 62 and other sheets can be arranged in pocket 64 or 66 and 68. Further, cover sheets are arranged in pocket 70 and collation line 60 selectively pulls sheets from the various pockets or bins for collation into a document. In an embodiment where inserts are pre-imaged, codes 32 are scanned by scanners 72 and 74 associated with pockets 56 and 58, respectively. The cover sheets in pocket 70 are imaged with recipient information at imaging station 76. Imaging system 78 images recipient information onto a cover sheet and transmits the recipient information along with code 32 to a file log 80. File log 80 is then transmitted to relational database 10. (Shown in FIG. 1).

Those skilled in the art will recognized that a wide variety of collating and imaging techniques are available for carrying out the imaging process illustrated in FIG. 6. Accordingly, the particular arrangement illustrated in FIG. 6 is merely exemplary of one of the number of different collating and imaging methods.

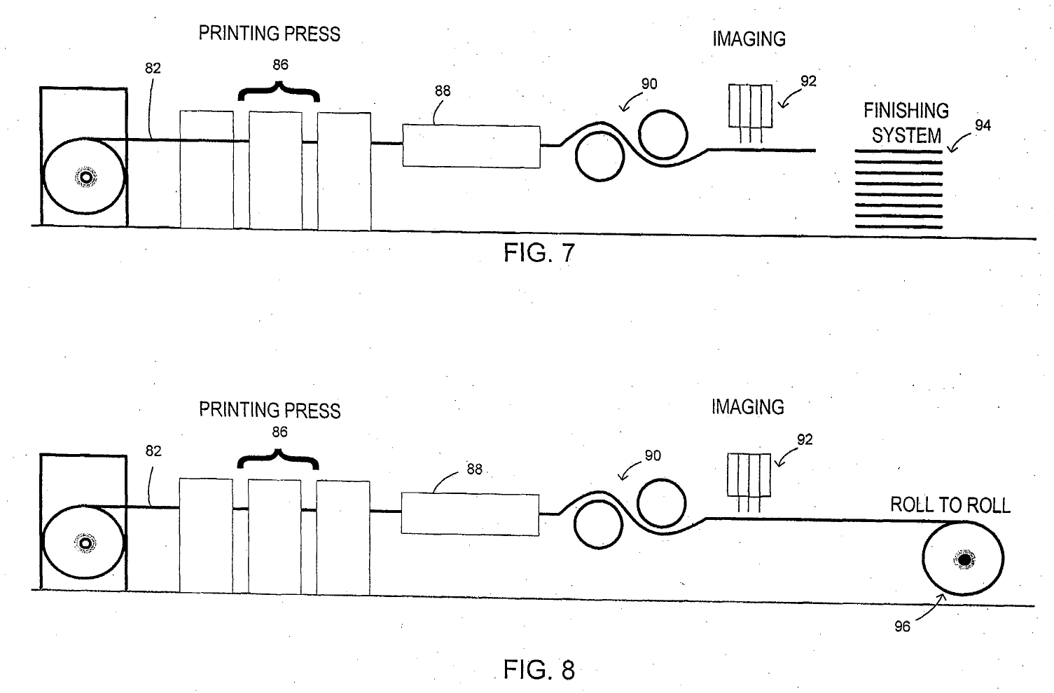

The inserts arranged in pockets 56 and 58 can be pre-imaged using a variety of printing techniques. For example, in FIG. 7, a continuous web 82 is dispensed from a role 84 and conveyed through a printing press 86. At printing press 86 various information and art work is printed onto web 82 that is cured at curing station 88. Web 82 then is conveyed through tension rollers 90 and code 32 is imaged onto web 82 by imaging system 92. The inserts are finished by a sheeter 94, such that stacks of inserts can be delivered for use in collating system 60.

An alternative method for preparing inserts is illustrated in FIG. 8. The alternative method includes the same processing steps as illustrated in FIG. 7 with the exception that sheeter 94 is replaced by a take up role system 96. Using the system illustrated in FIG. 8, inserts can be stored in rolled web and transferred to other processing systems that operate from a feed roll to further process the inserts prior to delivery to collation line 60.

Thus, it is apparent that there has been describe a system and method for tracking commercial activity that is initiated by print and electronic media providers that fully provides the advantages set forth above. Those skilled in the art will recognize that numerous modifications and variations can be made without departing from the spirit of the invention. For example, business-to-business transactions can be collected in a relational database in addition to consumer transactions. Accordingly, all such variations and modifications are within the scope of the appended claims and equivalents thereof.

1. A method for tracking advertising effectiveness by a mailing originator, the method comprising:
a) pre-imaging a code onto an insert;
b) applying recipient information onto a mailing host, associating the code with the recipient information, and creating a log file;
c) delivering the mailing host and the insert to the recipient;
d) collecting insert use information by the recipient and using the log file to identify the recipient; and
e) creating a marketing database.

2. The method of claim 1, wherein creating a marketing database comprises creating files identifying a particular recipient and the insert use information by the recipient.

3. The method of claim 2 further comprising transmitting at least selected files to marketing entities.

4. The method of claim 3, wherein transmitting the selected files to marketing entities comprises transmitting the selected files to marketing entities identified with the insert.

5. The method of claim 1, wherein applying recipient information onto a mailing host comprises imaging recipient name and address information on the mailing host.

6. The method of claim 5, wherein imaging recipient name and address information on the mailing host comprises imaging recipient name and address information on a publication.

7. The method of claim 6 further comprising binding the publication.

8. The method of claim 5, wherein imaging recipient name and address information on the mailing host comprises imaging recipient name and address information on one of an envelope, a loose sheet, or an overwrap.

9. The method of claim 1 further comprising scanning the random code by a third party, and wherein collecting insert use information comprises receiving the random code from the third party.

10. The method of claim 1, wherein pre-imaging a code comprises imaging a bar code containing one or more of a random number or a sequence number.

11. The method of claim 1, wherein pre-imaging a code comprises imaging a customized URL onto the insert.

12. The method of claim 11, wherein collecting insert use information comprises monitoring an electronic file server for contacts identifying the customized URL.

13. The method of claim 1, wherein pre-imaging a code comprises imaging a customized electronic messaging code onto the insert.

14. The method of claim 13, wherein collecting insert use information comprises monitoring an electronic file server for contacts identifying the electronic messaging code.

15. The method of claim 1, wherein using the log file to identify the recipient comprising downloading the log file into a mailing host computer system and creating a relational database.

17. The method of claim 1, wherein pre-imaging a code onto an insert comprises feeding a roll of inserts, each insert having a code thereon, and finishing the inserts.

18. The method of claim 1, wherein pre-imaging a code onto an insert comprises:
a) feeding a roll of inserts;
b) imaging an individual code onto each insert; and
c) gathering the inserts.

16. A method for tracking consumer transactions using inserts having random codes thereon, the method comprising:
a) scanning the random code on an insert;
b) applying recipient information onto a mailing host, associating the random code with the recipient information, and creating a file log;
c) associating the insert with the mailing host;
d) delivering the mailing host and the insert to a recipient;
e) receiving the random code and using the log file to identify the recipient; and
f) creating a marketing database.

17. The method of claim 16, wherein applying recipient information onto a mailing host comprises tracking the random code and the insert through a collation line and feeding a cover sheet from a feeder through an imaging system to image recipient name and address information on the cover sheet.

18. The method of claim 17, wherein associating the insert with the mailing host comprises grouping the cover sheet with additional sheets and inserting the insert with the additional sheet.

19. The method of claim 18, wherein grouping the cover sheet with additional sheets comprises binding the cover sheet and the additional sheets.

20. The method of claim 18, wherein grouping the cover sheet with additional sheets comprises attaching the cover sheet to an envelope inserting the additional sheets and the insert into the envelope.

21. The method of claim 17, wherein associating the insert with the mailing host comprises applying the cover sheet and the insert to a product.

23. The method of claim 16, wherein scanning the random code and receiving the random code comprises scanning the code from an RF tag positioned on the insert and transmitting the code to a receiver.

24. The method of claim 16, wherein scanning the random code receiving the random code comprises reading the code from a magnetic strip positioned on the insert and transmitting the code to a receiver.

25. A method for tracking commercial activity, the method comprising:
a) imaging an insert with dynamic information;
b) associating the insert with a mailing host, applying recipient identification information to the mailing host, and creating a log file;
c) delivering the mailing host and the insert to the recipient;
d) collecting the dynamic information and using the log file to identify the recipient; and
e) creating a marketing database.

26. The method of claim 25, wherein imaging an insert with dynamic information comprises unwinding a web and imaging sections of the web with printed information.

27. The method of claim 26 further comprising cutting the web and organizing the inserts as groups of sheets suitable for use in collating a publication.

28. The method of claim 26 further comprising taking up the imaged sections of the web and storing the web for later use.
